(19) United States
(12) Patent Application Publication
(10) Pub. No.: US 2017/0055662 A1
(43) Pub. Date: Mar. 2, 2017

(54) SYSTEM, APPARATUS, AND METHOD OF HOLDING KEYS

(71) Applicant: Michael TAYLOR, Savannah, GA (US)

(72) Inventor: Michael TAYLOR, Savannah, GA (US)

(21) Appl. No.: 14/836,584

(22) Filed: Aug. 26, 2015

(51) Int. Cl. A45C 11/32; A45D 24/10; B25F 1/00

(52) U.S. Cl. CPC A45C 11/324; A45C 11/321; B25F 1/00; A45D 24/10

(57) ABSTRACT

According to an exemplary embodiment, a key holder may be provided. The key holder may include a first element and a second element, having at least two holes disposed therethrough. The first element and the second element may be mounted on at least two key retention posts that may be configured to be inserted in the first element and the second element, thereby connecting the first element to the second element. A number of washers and accessories may be rotatably mounted on the key retention posts between the first and the second element. A clip may be inserted into an opening in at least one of the first element and the second element and may be connected to one of the of key retention posts.

### BACKGROUND

The way we carry and keep keys organized has not fundamentally changed in the last few decades. Keys are generally carried as a set, connected to a key ring through an opening in the key bows. However, this way of carrying keys presents a major disadvantage: keys have exposed sharp teeth and points that can be uncomfortable while carried in a pocket. Furthermore, the sharp teeth and points can also catch onto, rip, and perforate fabric inside a pocket or a bag. Another significant drawback of carrying keys simply threaded on a key ring is the noise created by the keys rattling against each other and the wear and tear imparted to the keys by repeated contact with hard surfaces. There is a need to consolidate, debulk, and organize keys in a way that protect both the person who carries the keys, but also the keys themselves, while alleviating the noise and the clutter associated with traditional ring systems.

### SUMMARY

According to an exemplary embodiment, a key holder may be provided. The key holder may include a first element and a second element, having at least two holes disposed therethrough, each capable of receiving a key retention post. The first element and the second element may be mounted on key retention posts that may be configured to be inserted in the first element and the second element, thereby connecting the first element to the second element. A number of washers and accessories may be rotatably mounted on the key retention posts between the first and the second element. A clip may be inserted into an opening in the at least one of first element and the second element and may be connected to one of the of key retention posts.

According to another exemplary embodiment, a method of holding keys may be provided. The method of holding keys may include obtaining a first element and placing retention posts through holes in the first element. Then inserting a clip in an opening in the second element and connecting the clip to one of the of key retention posts. This may be followed by mounting a number of washers, keys, clips, and accessories on a number of key retention posts, and securing the number of key retention posts to the first element and second element.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a diagram showing a perspective view of an exemplary embodiment of a key holder;

FIG. 2 is a diagram showing side view of an exemplary embodiment of a key holder;

FIG. 3 is a diagram showing a perspective view of an exemplary embodiment of a key holder clip; and

FIG. 4 is a diagram showing an exemplary embodiment of a method of holding keys.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

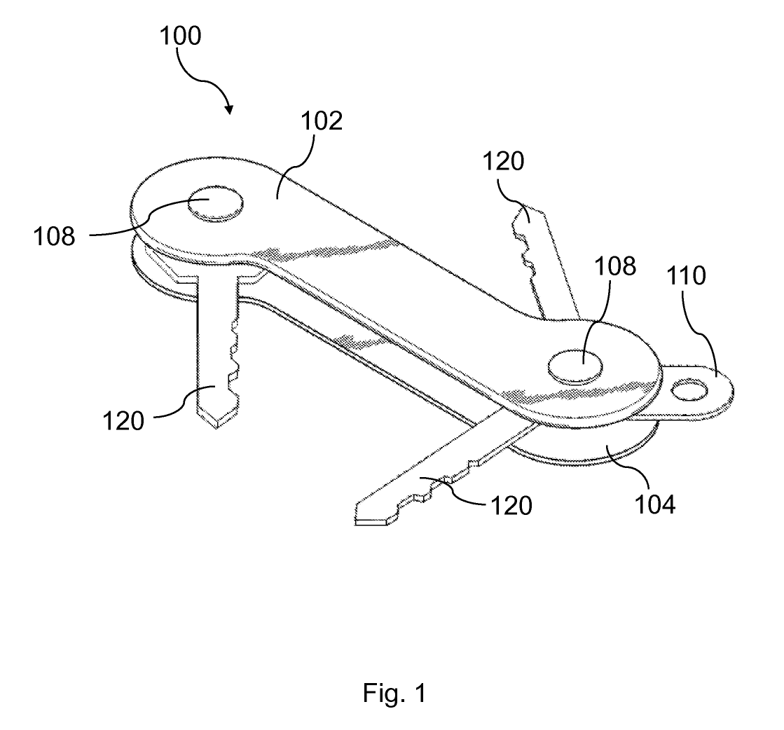

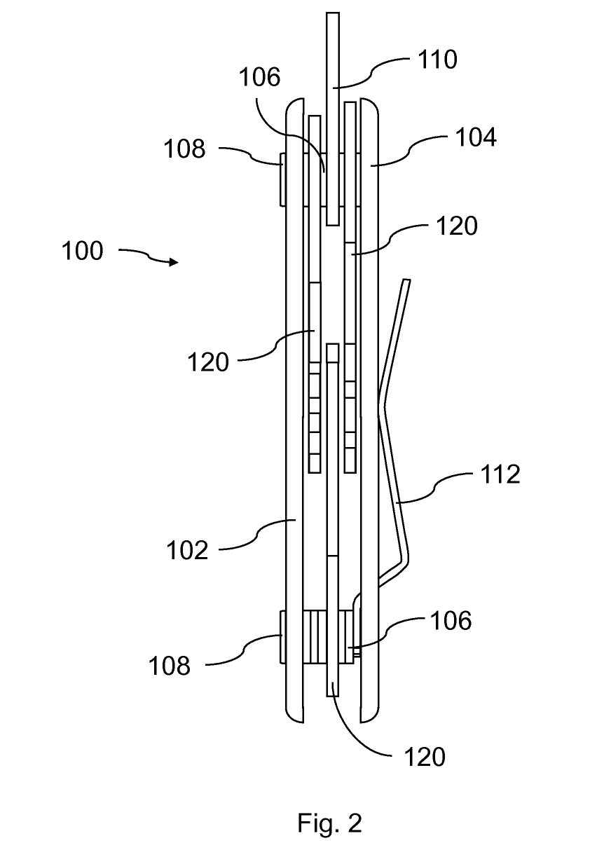

Referring to FIG. 1 and FIG. 2, an exemplary embodiment of a key holder may be provided. The key holder 100 may include a first element 102 connected to a second element 104 through a number of key retention posts 108. The first element 102 may have at least two openings capable of receiving a number of key retention posts 108. It may be appreciated that one end of the key retention posts may have a head that may be retained by the first element 102 and the second element 104. The at least two openings may be distally located along the length of the first element 102 and the second element 104. The second element 104 may have at least one opening also capable of receiving a key retention post 108. A first end of a number of key retention posts may be proximate first element 102 and a second end of a number of key retention posts may be proximate second element 104.

In an exemplary embodiment, the at least one opening in the second element 104 may optionally be threaded so as to engage a threaded portion on the at least two key retention posts 108, consequently securely connecting the first element 102 and the second element 104. Alternatively, the at least two key retention posts 108 may be passed through the opening in the second element 102 and engage a threaded fastener. The threaded fastener may engage the second element 102 and connect the second element 102 to the at least two key retention posts 108. A number of washers 106, keys 120, attachment rings 110, and any desired accessories may be rotatably mounted on the number of key retention posts 108. In another exemplary embodiment, the key retention post 108 may include, but not be limited to, screws, nuts and bolts, and screw posts. It may be appreciated that the key retention post may be constructed with any desired structural elements as would be understood by a person having ordinary skill in the art.

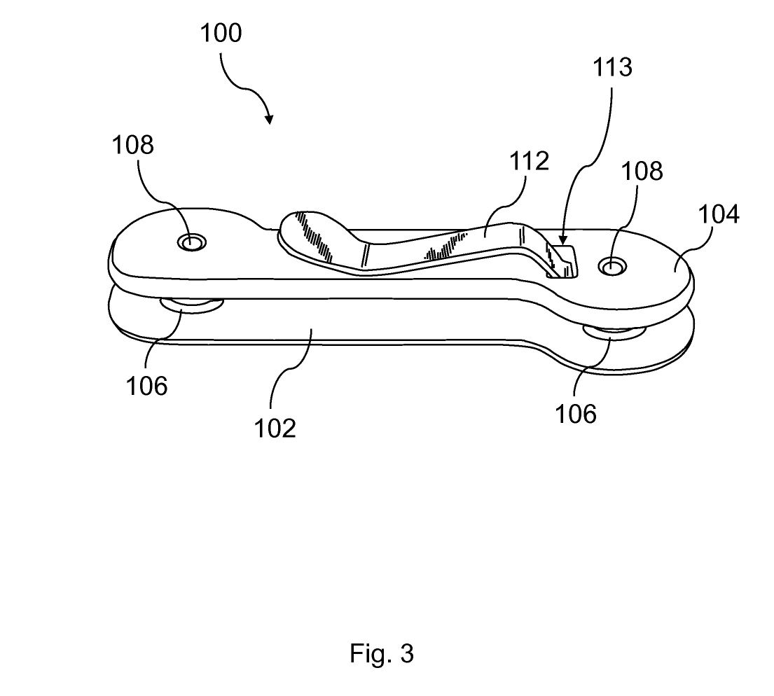

In a further embodiment illustrated in FIG. 3, a clip 112 may be provided. The clip may optionally be inserted through an opening 113 in the second element 104 and mounted on at least one key retention posts 108. The clip may help secure the key holder 100 to a user's garment or equipment. For example, the clip may be used to secure the key holder 100 to a pocket, a belt, a bag, or a vest. The clip may be connected to the first or second element with screws or any other desired fasteners as would be understood by a person having ordinary skill in the art. Further, the clip may be made of a number of materials including, but not limited to carbon fiber, ceramics, polymers, metals, and alloys.

In an exemplary embodiment, the length of the key retention posts 108 and the number of washers 106 may be selected to accommodate the desired number of keys and accessories. The keys 120 may be mounted on a key retention posts 108 in such a way that they may be disposed between the first element 102 and second element 104, as illustrated in FIG. 1. Further, the number of washers 106 may be partly substituted by a number of keys 120 and accessories. Further, accessories may include, but not limited to, attachment rings 110, bottle openers, carabiners, screwdrivers, USB drives, combs, and any utility accessories that may typically be found in a multifunction tool. In another exemplary embodiment, attachment rings 110 may be connected to a lanyard, an electronic key, a key fob, an RFID tag, a proxy-card, and any kind of electronic or physical identification means. Further, the attachment ring may also be coupled to a connector such as a carabiner for securing the key holder to a piece of garment, a piece of equipment or any desired anchor.

In an exemplary embodiment, the first element 102 and the second element 104 may be made of a number of materials including, but not limited to carbon fiber, ceramics, polymers, metals, and alloys. It may be appreciated that the first element 102 and the second element 104 may be made of different materials as would be understood by a person having ordinary skill in the art. For example, the first element may be made of carbon fiber and the second element may be made of titanium or stainless steel. Further, it may be appreciated that the first element 102 and second element 104 may have a number of decorative finishes, including but not limited to, nitride coating, anodizing, images, logos, text, pattern, and textured carving. The first element 103 and the second element 104 may be made with any desired materials and treated with any desired finishes. Further, the clip 112 may optionally be decorated and personalized, as desired.

In an exemplary embodiment, the key holder 100 may have a length from about 2 inches to about 6 inches and a weight from about 1 ounce to about 12 ounces. In another exemplary embodiment, the key holder 100 may have a weight of about 3.5 ounces. However, it may be appreciated that the key holder 100 may have any desired length and weight.

In an exemplary embodiment, the number of washers 106 may be mounted anywhere on the number of key retention posts 108. For example, the number of washers 106 may be placed where the underside of the head of a key retention posts 108 may be in contact with the first element. In a further exemplary embodiment, washers 106 may be made of any desired material including, but not limited to, metal, PTFE, rubber, silicone, metal, cork, felt, neoprene, nitrile rubber, fiberglass, and plastic polymer.

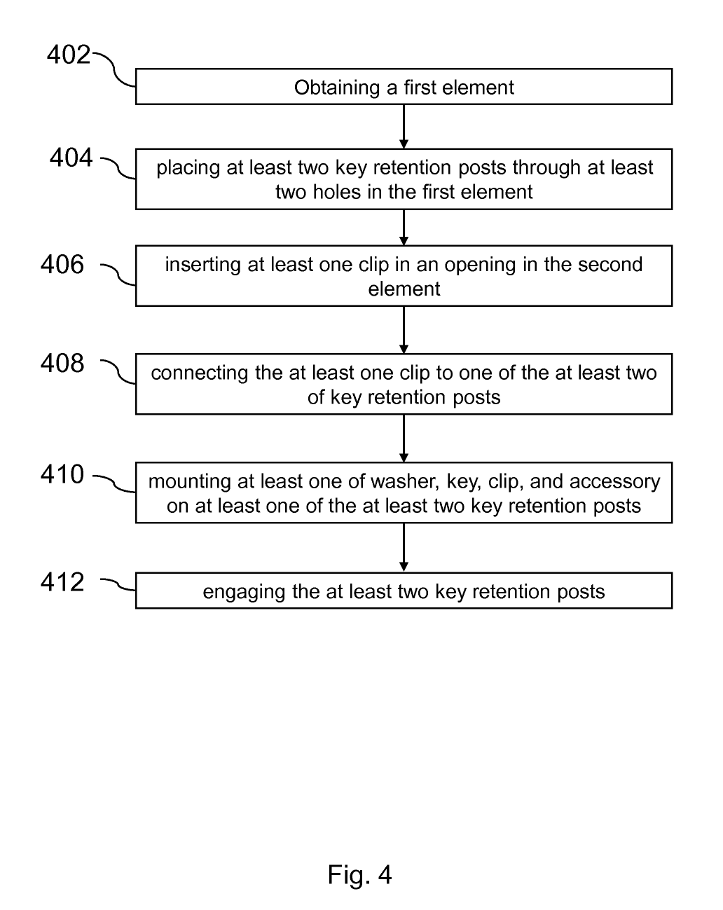

In an exemplary embodiment illustrated in FIG. 4, a method of holding keys may be provided. The method of holding keys may include obtaining a first element 402 and placing a number of retention posts through at least two holes in the first element 404. Then inserting a number of clips in an opening in the second element 406 and connecting the number of clips to one of the number of key retention posts 408. This may be followed by mounting a number of washers, keys, clips, and accessories on a number of key retention posts 410, and threadably engaging the number of key retention posts 412.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A key holder comprising:
a first element having at least two holes disposed therethrough, each capable of receiving a key retention post;
a second element having at least two holes disposed therethrough, each capable of receiving a key retention post;
at least two key retention posts each configured to be inserted in one of the at least two holes of the first element and one of the at least two holes of the second element, connecting the first element to the second element;
at least one washer rotatably mounted on the at least two key retention posts between the first and the second element;
at least one accessory, rotatably mounted on the at least two key retention posts between the first and the second element; and
at least one clip inserted into an opening in at least one of the first element and the second element and connected to one of the at least two of key retention posts.

2. The key holder of claim 1, wherein the at least one washer is made of at least one of metal, PTFE, rubber, silicone, metal, cork, felt, neoprene, nitrile rubber, fiberglass, and plastic polymer.

3. The key holder of claim 1, wherein the at least one clip is made of at least one of stainless steel, carbon fiber, and titanium.

4. The key holder of claim 1, wherein the accessory is one of a key, attachment ring, a bottle opener, a carabiner, a screwdriver, a USB drive, a comb, and a utility accessory.

5. The key holder of claim 1, wherein the at least two holes in the second element are threaded to engage a threaded end of the at least two key retention posts.

6. The key holder of claim 1, wherein each of the at least two key retention posts are inserted in one of the at least two holes of the first element and one of the at least two holes of the second element and engage a threaded fastener.

7. The key holder of claim 6, wherein the treaded fastener connects one of the at least two key retention posts to the second element.

8. The key holder of claim 1, wherein at least one of the first element and the second element is made of a least one of stainless steel, carbon fiber, titanium, brass, aluminum, and copper.

9. The key holder of claim 8, wherein at least one of the first element and the second element is finished with at least one of nitride coating, anodizing, images, logos, text, pattern, and textured carving.

10. The key holder of claim 8, wherein the first element is made of carbon fiber.

11. The key holder of claim 1, wherein the length of the key holder is from approximately 2 inches to approximately 6 inches and the weight of the key holder is from approximately 1 ounce to approximately 20 ounces.

12. The key holder of claim 11, wherein the length of the key holder is approximately 3.5 inches.

13. A method of storing keys comprising:
obtaining a first element;
placing at least two key retention posts through at least two holes in the first element;
inserting at least one clip in an opening in the second element;
connecting the at least one clip to one of the at least two of key retention posts;
mounting at least one of washer, key, clip, and accessory on at least one of the at least two key retention posts; and
securing the at least two key retention posts.

14. The method of claim 13, wherein the washer is made of at least one of metal, PTFE, rubber, silicone, metal, cork, felt, neoprene, nitrile rubber, fiberglass, and plastic polymer.

15. The method of claim 13, wherein the clip is made of at least one of stainless steel, carbon fiber, and titanium.

16. The method of claim 13, wherein the accessory is one of a key, an attachment ring, a bottle opener, a carabiner, a screwdriver, a USB drive, a comb, and a utility accessory.

17. The method of claim 13, wherein at least one of the first element and the second element is made of a least one of stainless steel, carbon fiber, titanium, brass, aluminum, and copper.

18. The method of claim 17, wherein at least one of the first element and the second element is finished with at least one of nitride coating, anodizing, images, logos, text, pattern, and textured carving.

19. The method of claim 13, wherein the length of the key holder is from approximately 2 inches to approximately 6 inches and the weight of the key holder is from approximately 1 ounce to approximately 20 ounces.

20. The method of claim 19, wherein the length of the key holder is approximately 3.5 inches.
